(19) United States
(12) Patent Application Publication
(10) Pub. No.: US 2026/0176894 A1
(43) Pub. Date: Jun. 25, 2026

(54) LOCK DEVICE

(71) Applicant: HI-LEX ACT Corporation, Yokohama-shi (JP)

(72) Inventors: Yoshiaki YOKOTA, Kanagawa (JP); Koji OGASAWARA, Kanagawa (JP)

(73) Assignee: HI-LEX ACT Corporation, Yokohama-shi (JP)

(21) Appl. No.: 19/425,852

(22) Filed: Dec. 18, 2025

(30) Foreign Application Priority Data
Dec. 25, 2024 (JP) 2024-228647

(51) Int. Cl. E05B 81/20; E05B 81/06; E05B 81/46; E05B 81/66

(52) U.S. Cl. CPC E05B 81/20; E05B 81/06; E05B 81/46; E05B 81/66

(57) ABSTRACT

A door lock device includes a meshing mechanism having a latch and a pawl, a latch detector detecting a position of the latch by coming into contact with a detected portion rotating integrally with the latch, and an electric driving mechanism performing a closing operation for electrically shifting the meshing mechanism to an engaged state based on a detection result of the latch detector. The meshing mechanism is provided with a latch lead-in portion that receives a driving force of a motor when the electric driving mechanism performs the closing operation, and the latch lead-in portion and the latch detector are arranged at positions different from each other in an axial direction of the latch, and where at least parts thereof overlap each other as viewed from the axial direction.

### CROSS-REFERENCE TO RELATED APPLICATIONS

This application is based on and claims priority under 35 USC 119 from Japanese Patent Application No. 2024-228647 filed on Dec. 25, 2024, the entire content of which is incorporated herein by reference.

### TECHNICAL FIELD

The present disclosure relates to a lock device that is engaged with a striker provided in a vehicle to hold an opening and closing body of the vehicle in a closed state.

### BACKGROUND ART

This section provides background information related to lock devices and is not necessarily prior art to the lock device of the present disclosure.

A door lock device of a vehicle is known (for example, see JP5732694B and CN108678575B), in which the device has a closing function of moving a latch in a half latch position to a full latch position by a driving force from a motor.

The electric lock (door lock device) described in JP5732694B includes a tongue piece (latch), a pallet (pawl), an operation member that is fixed to the tongue piece, a drive lever that is engaged with the operation member and drives the tongue piece from a half latch position to a full latch position by an operation of an actuator, and a first position sensor that detects a position of the tongue piece by coming into contact with the drive lever.

The door lock device described in CN108678575B includes a lock hook (latch), a ratchet pawl (pawl), a trigger lever that has one end rotatably installed on the ratchet pawl and the other end coming into contact with a guide arc surface provided on the lock hook, and a first microswitch that enables to come into contact with the trigger lever. When the lock hook is not engaged with the striker, the first micro switch is turned ON by coming into contact with the trigger lever, and when the lock hook is engaged with the striker, the first micro switch is turned OFF by not coming into contact with the trigger lever.

### SUMMARY OF INVENTION

The present disclosure provides a lock device for an opening and closing body, which achieves miniaturization while ensuring detection accuracy of a position of a latch.

An aspect of the present disclosure relates to a door lock device configured to engage with a striker provided in a vehicle to hold an opening and closing body of the vehicle in a closed state, the door lock device including:
a meshing mechanism including a latch configured to be engaged with the striker, and a pawl configured to maintain an engaged state in which the striker and the latch are engaged with each other;
a latch detector configured to detect a position of the latch by coming into contact with a detected portion that rotates integrally with the latch; and
an electric driving mechanism including a motor and a driving force transmission portion configured to transmit a driving force of the motor, the electric driving mechanism being configured to perform a closing operation for electrically shifting the meshing mechanism to the engaged state based on a detection result of the latch detector, in which
the meshing mechanism is provided with a latch lead-in portion provided in conjunction with the latch and configured to receive a driving force of the motor transmitted from the driving force transmission portion in a case where the electric driving mechanism performs the closing operation, and
the latch lead-in portion and the latch detector are arranged at positions different from each other in an axial direction of the latch, and where at least parts of the latch lead-in portion and the latch detector overlap each other as viewed from the axial direction.

According to the present disclosure, it is possible to achieve miniaturization while ensuring the detection accuracy of the position of the latch.

### BRIEF DESCRIPTION OF DRAWINGS

Exemplary embodiment(s) of the present invention will be described in detail based on the following figures, wherein:

FIG. 1 shows an example of a vehicle 1 to which a door lock device 10 is attached;

FIG. 2 is a perspective view of the door lock device 10;

FIG. 3 is a perspective view showing an internal structure of the door lock device 10;

FIG. 4 is a perspective view of the internal structure of the door lock device 10 as viewed from the +Y side and the +Z side;

FIG. 5 shows the internal structure of the door lock device 10 as viewed from the −Z side;

FIG. 6 is an exploded perspective view of a latch 21 and a resin portion 21B;

FIG. 7 is an exploded perspective view of the latch 21, a detected portion 30, and a latch shaft 24;

FIG. 8 is a side view of the latch 21, the detected portion 30, and a latch detector 71 viewed from the −X side;

FIG. 9 is a block diagram showing a control system of the door lock device 10;

FIG. 10 is an operation explanatory view (part 1) of a meshing mechanism 20 and an electric driving mechanism 50 when a closing operation is performed;

FIG. 11 is an operation explanatory view (No. 2) of the meshing mechanism 20 and the electric driving mechanism 50 when the closing operation is performed;

FIG. 12 is an operation explanatory view (No. 3) of the meshing mechanism 20 and the electric driving mechanism 50 when the closing operation is performed;

FIG. 13 is an operation explanatory view (No. 4) of the meshing mechanism 20 and the electric driving mechanism 50 when the closing operation is performed;

FIG. 14 is an operation explanatory view (part 5) of the meshing mechanism 20 and the electric driving mechanism 50 when the closing operation is performed;

FIG. 15 is an operation explanatory view (part 1) of the meshing mechanism 20 and the electric driving mechanism 50 when an opening operation is performed;

FIG. 16 is an operation explanatory view (No. 2) of the meshing mechanism 20 and the electric driving mechanism 50 when the opening operation is performed;

FIG. 17 is an operation explanatory view (No. 3) of the meshing mechanism 20 and the electric driving mechanism 50 when the opening operation is performed;

FIG. 18 is an operation explanatory view (No. 4) of the meshing mechanism 20 and the electric driving mechanism 50 when the opening operation is performed; and

FIG. 19 is a view showing a contact surface 34 of the detected portion 30 with the latch detector 71 arranged on a rotation locus (thick arrow) of a pawl contact portion 21e.

### DESCRIPTION OF EMBODIMENTS

Hereinafter, a lock device according to an embodiment of the present disclosure will be described in detail with reference to the accompanying drawings. In the embodiment described below, a configuration in which the lock device is attached to a back door (an example of an opening and closing body) of a vehicle and a closed state of the back door is held will be described as an example.

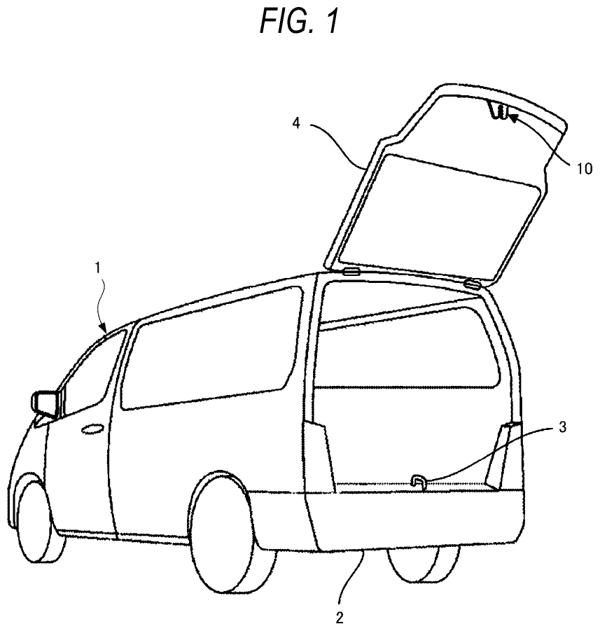

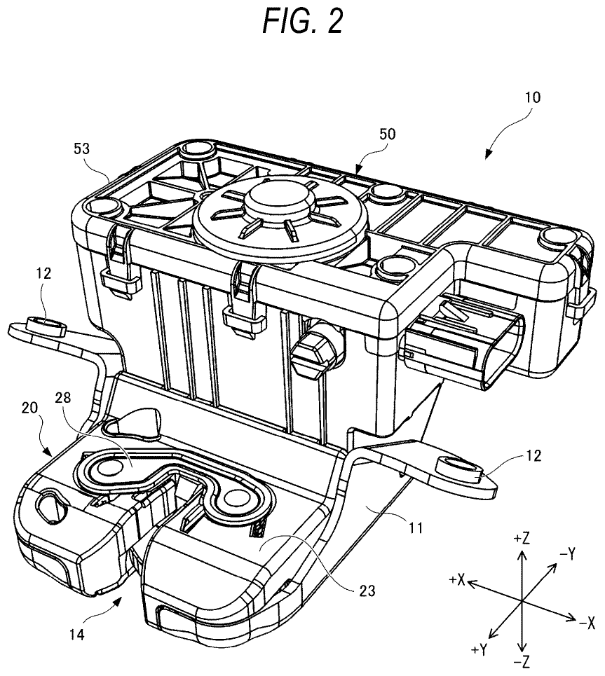

FIG. 1 shows an example of a vehicle 1 to which a door lock device 10 (an example of the lock device) is attached. The door lock device 10 is attached to a back door 4 that rotates in the vertical direction with respect to a body 2. The door lock device 10 holds the back door 4 in a fully closed state by engaging with a striker 3 provided on the body 2. In the following explanation, arrow directions shown in the drawings are referred to as an X direction, a Y direction, and a Z direction, respectively. Specifically, the Z direction is a direction in which a latch shaft 24 and a pawl shaft 26 described later extend, the Y direction is a direction orthogonal to the Z direction and in which a striker entry groove 14 described later extends, and the X direction is a direction orthogonal to the Y direction and the Z direction. 12 As illustrated in FIGS. 2 to 5, the door lock device 10 includes a meshing mechanism 20, an electric driving mechanism 50 including a motor 51, a latch detector 71, a pawl detector 72, a gear detector 73, and a cover plate 11 that covers these components from the −Z side. 13 The cover plate 11 is provided with fixing portions 12 for attaching the door lock device 10 to the back door 4 at both end portions in the X direction. The door lock device 10 is attached by inserting bolts into through holes provided in a panel of the back door 4 and fastening the bolts to bolt holes (threaded portions) of the fixing portion 12 of the cover plate 11.

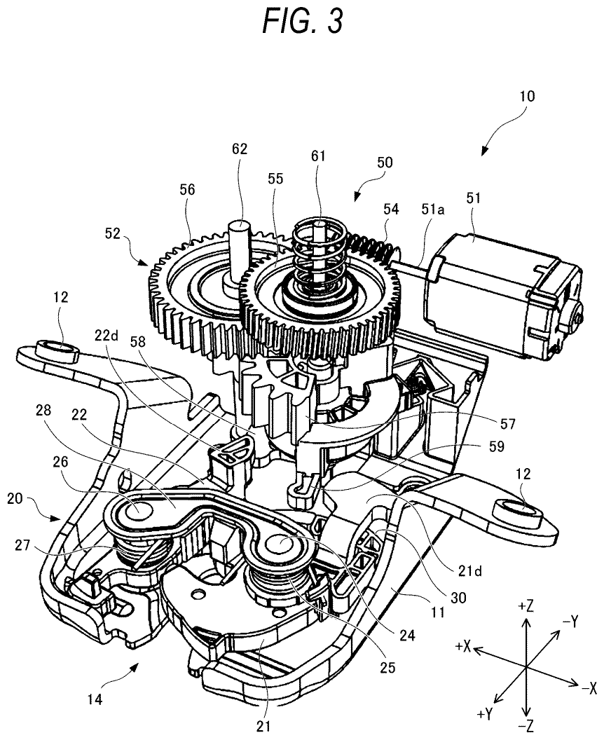

The meshing mechanism 20 is arranged on the +Y side of the electric driving mechanism 50 in the Y direction and is arranged on the −Z side of the fixing portion 12 in the Z direction. The meshing mechanism 20 includes a latch 21 that is engaged with the striker 3, a pawl 22 that maintains an engagement state in which the striker 3 and the latch 21 are engaged with each other, and a housing 23 that accommodates the latch 21 and the pawl 22. FIGS. 3 to 5 show states of the latch 21 and the pawl 22 when the back door 4 is in the fully closed state. However, the striker 3 is not shown.

The housing 23 and the cover plate 11 are provided with a striker entry groove 14 into which the striker 3 enters when the back door 4 is closed. The striker entry groove 14

extends in the Y direction and opens on the +Y side. The latch 21 and the pawl 22 are arranged to sandwich the striker entry groove 14, and specifically, the latch 21 is arranged on the −X side with respect to the striker entry groove 14, and the pawl 22 is arranged on the +X side with respect to the striker entry groove 14.

The latch 21 is provided to be rotatable around a latch shaft 24 extending in the Z direction. The latch 21 is always biased by a latch spring 25 in a direction to release the striker 3. The latch spring 25 is a torsion spring wound around the latch shaft 24. The Z direction is a direction in which the latch shaft 24 extends, and may be referred to as an axial direction of the latch 21.

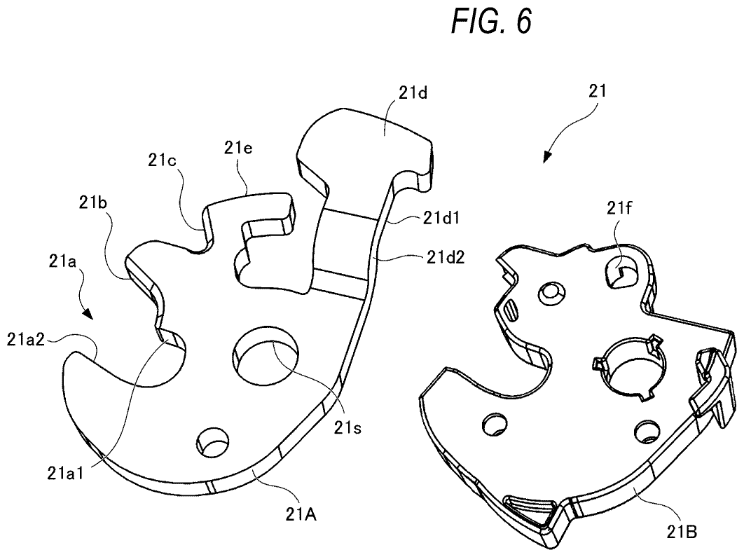

As illustrated in FIG. 6, the latch 21 includes a metal portion 21A formed of a metal plate-shaped member and a resin portion 21B covering a part of the metal portion 21A. The resin portion 21B is provided around the metal portion 21A by molding the metal portion 21A with a synthetic resin material. As the synthetic resin material forming the resin portion 21B, for example, a material having a high acoustic absorption property is selected. In FIG. 6, the metal portion 21A and the resin portion 21B are separately illustrated for convenience of description.

The latch 21 includes an accommodation groove 21a capable of accommodating the striker 3, a full-latch meshing portion 21b, a half-latch meshing portion 21c, a pawl contact portion 21e, and a through hole 21s through which the latch shaft 24 is inserted. These are provided in the metal portion 21A and are arranged on the same plane in the Z direction in which the latch shaft 24 extends. The accommodation groove 21a, the full-latch meshing portion 21b, the half-latch meshing portion 21c, and the pawl contact portion 21e are provided side by side in this order in the circumferential direction of the latch 21.

The accommodation groove 21a is formed to be recessed radially inward (in a direction toward the through hole 21s) from the outer peripheral surface of the latch 21. The accommodation groove 21a includes a striker contact portion 21a1 and a hook portion 21a2, and the striker contact portion 21a1 and the hook portion 21a2 face each other to form the accommodation groove 21a.

The pawl contact portion 21e is provided adjacent to the half latch meshing portion 21c on the outer peripheral surface of the latch 21. The pawl contact portion 21e has an arc shape centered on the latch shaft 24. The pawl 22 comes into contact with the pawl contact portion 21e when the latch 21 is at the unlatched position where the latch 21 is not engaged

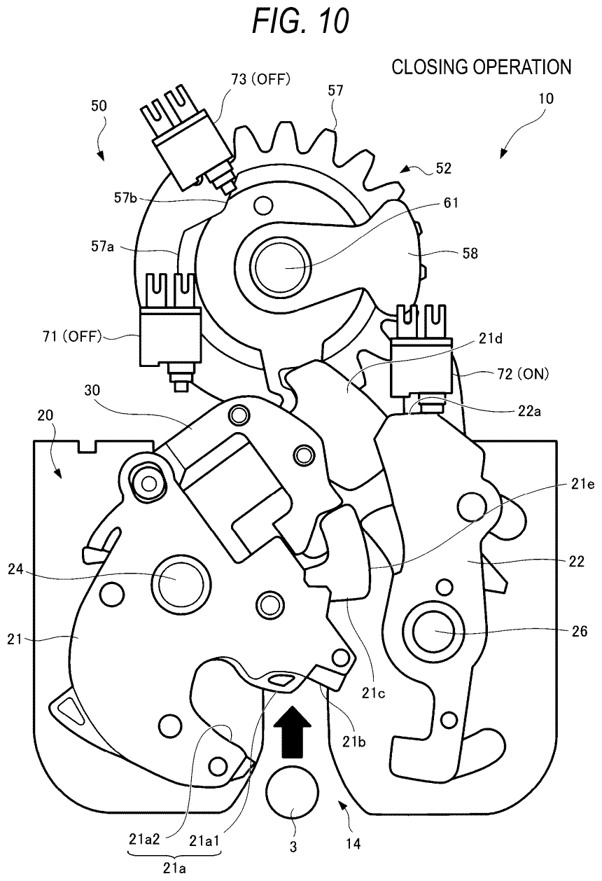

with the striker 3 (see FIG. 10).

Further, the latch 21 includes a latch lead-in portion 21d that is pressed by a latch operation portion 58 (described later) of the electric driving mechanism 50 to receive a driving force of the motor 51. When the latch lead-in portion 21d receives the driving force of the motor 51, the latch 21 rotates in a direction of retracting the striker 3 (closing direction).

The latch lead-in portion 21d is formed by bending a part of the metal portion 21A of the latch 21. Specifically, the metal portion 21A of the latch 21 is formed with an extension portion 21d1 extending to the outer peripheral side, and the latch lead-in portion 21d is formed in a stepped shape by bending the extension portion 21d1 to the +Z side and further bending the bent extension portion 21d1 to the−Y side. This step portion is also referred to as a step portion 21d2. With this configuration, the latch lead-in portion 21d is arranged at a position different from the accommodation groove 21a, the full-latch meshing portion 21b, the half-latch meshing portion 21c, and the through-hole 21s in the Z direction.

The extending direction of the latch lead-in portion 21d is substantially parallel to the extending direction of the striker entry groove 14 when the engagement mechanism 20 is in an engaged state (full latch position described later) in which the engagement mechanism 20 is engaged with the striker 3 (see FIGS. 3 to 5).

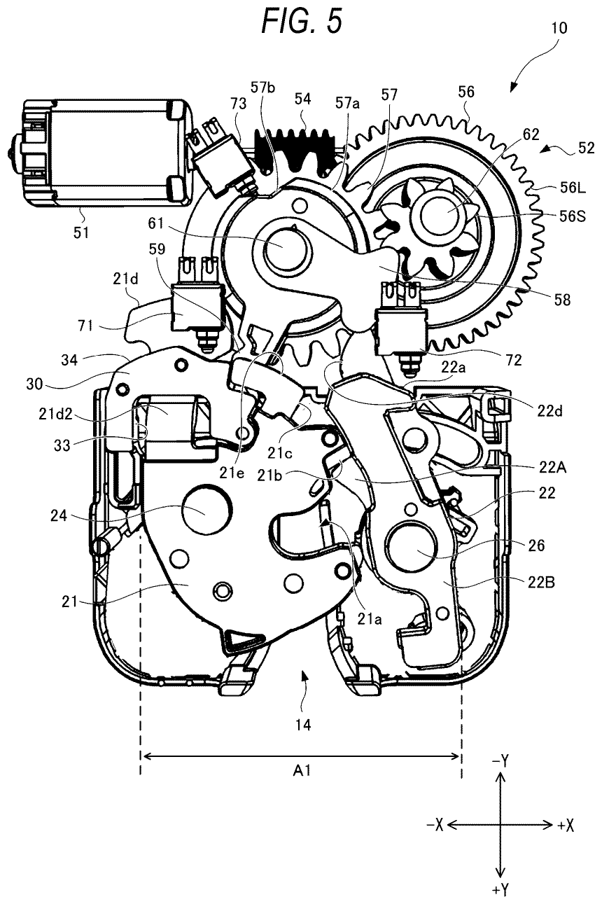

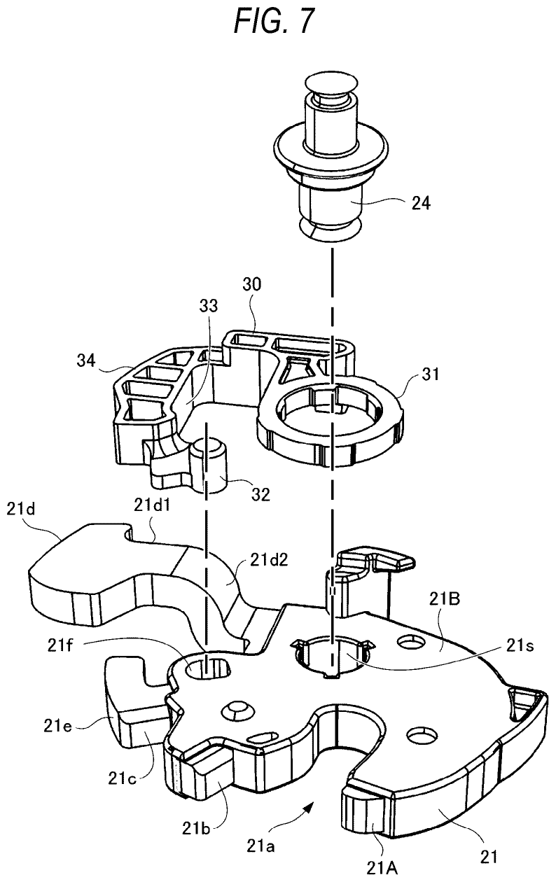

As shown in FIG. 5 and FIG. 7, the detected portion 30 that rotates integrally with the latch 21 and enables to come into contact with the latch detector 71 is attached to the latch 21 as a separate component from the latch 21. The detected portion 30 is formed of, for example, a resin. The latch detector 71 is arranged on the-Y side of the latch shaft 24, and the detected portion 30 is arranged to be contactable with the latch detector 71. The latch detector 71 and the detected portion 30 are arranged on the same plane in the Z direction in which the latch shaft 24 extends.

A contact surface 34 of the detected portion 30 with the latch detector 71 is arranged on the same plane in the Z direction as a portion of the latch 21 excluding the latch lead-in portion 21d. The contact surface 34 is arranged adjacent to the pawl contact portion 21e of the latch 21.

The detected portion 30 includes a first attachment portion 31 and a second attachment portion 32 that are attachment parts where the latch 21 is attached. The first attachment portion 31 is arranged on the +Z side with respect to the latch 21 and is formed from a through hole through which the latch shaft 24 is inserted. The second attachment portion 32 is formed as a convex portion inserted into a through hole 21f provided in the resin portion 21B of the latch 21. The through hole 21f is provided at a position not overlapping the metal portion 21A of the latch 21 as viewed from the Z direction, and penetrates in the Z direction. The second attachment portion 32 is arranged on the −Z side with respect to the latch 21 and is inserted into the through hole 21f from the −Z side. In this way, the latch shaft 24 is inserted into the through hole 21s of the latch 21 and the first attachment portion 31, and the second attachment portion 32 is inserted into the through hole 21f, whereby the detected portion 30 is attached to the latch 21. The detected portion 30 may be provided with three or more attachment portions.

The detected portion 30 further includes an insertion portion 33 through which the step portion 21d2 of the latch lead-in portion 21d is inserted. The insertion portion 33 is provided between the first attachment portion 31 and the second attachment portion 32. The detected portion 30 is arranged at a position different from the latch lead-in portion 21d in the Z direction in which the latch shaft 24 extends, and specifically, is arranged on the −Z side of the latch lead-in portion 21d.

As illustrated in FIGS. 3 to 5, the pawl 22 is provided to be rotatable around the pawl shaft 26 extending in the Z direction. The pawl 22 is biased by a pawl spring 27 in a direction in which the pawl 22 can mesh with the latch 21. The pawl spring 27 is a torsion spring wound around the pawl shaft 26.

Similarly to the latch 21, the pawl 22 also includes a metal portion 22A formed of a metal plate-shaped member and a resin portion 22B covering a part of the metal portion 22A (see FIG. 5). The pawl 22 meshes with the latch 21 at the metal portion 22A exposed from the resin portion 22B.

The pawl 22 includes a detected portion 22a that enables to come into contact with the pawl detector 72. The pawl detector 72 is arranged on the −Y side of the pawl shaft 26, and the detected portion 22a is arranged to be contactable with the pawl detector 72. The pawl detector 72 and the detected portion 22a are arranged on the same plane in the Z direction in which the pawl shaft 26 extends.

The pawl 22 includes a pressed portion 22d that is pressed by a pawl operation portion 59, which will be described later, of the electric driving mechanism 50 and receives a driving force of the motor 51. When the pressed portion 22d receives the driving force of the motor 51, the pawl 22 rotates in a direction of releasing the engagement with the latch 21 against the biasing force of the pawl spring 27. The pressed portion 22d and the pawl detector 72 are arranged at positions different from each other in the Z direction, and where at least parts of the pressed portion 22d and the pawl detector 72 overlap each other as viewed from the Z direction.

The detected portion 22a and the pressed portion 22d are provided on the resin portion 22B, for example, and rotate integrally with the pawl 22.

As shown in FIGS. 2 and 3, the latch shaft 24 and the pawl shaft 26 are fixed to a back plate 28 attached to the +Z side surface of the housing 23, and are supported by the cover plate 11 and the back plate 28.

When the back door 4 is closed, the striker 3 enters the striker entry groove 14 and is engaged with the latch 21, and rotates the latch 21 in the closing direction against the biasing force of the latch spring 25. The pawl 22 first meshes with the half-latch meshing portion 21c of the latch 21. The position of the latch 21 at this time is also referred to as a half latch position, and the back door 4 is in the half door state. When the striker 3 further advances, the pawl 22 next meshes with the full-latch meshing portion 21b. The position of the latch 21 at this time is also referred to as a full latch position, and the back door 4 is in a fully closed state in which the back door 4 is completely locked by the meshing mechanism 20. In this way, the pawl 22 meshes with the half-latch meshing portion 21c or the full-latch meshing portion 21b of the latch 21, and maintains the engagement state in which the striker 3 and the latch 21 are engaged with each other. The position of the latch 21 in a state in which the latch 21 is not engaged with the striker 3 is also referred to as an unlatched position, and the back door 4 is in an openable state in which the back door 4 is movable toward the fully open position.

The electric driving mechanism 50 performs a closing operation for electrically closing the back door 4 and an opening operation for electrically releasing the engagement between the striker 3 and the latch 21.

As illustrated in FIGS. 2 to 5, the electric driving mechanism 50 is arranged on the-Y side of the meshing mechanism 20 in the Y direction, and most of the electric driving mechanism 50 is arranged on the +Z side of the fixing portion 12. The electric driving mechanism 50 includes the motor 51, a driving force transmission portion 52 that transmits a driving force of the motor 51, and a housing 53 that accommodates the motor 51 and the driving force transmission portion 52.

The motor 51 is configured to be rotatable in forward and reverse directions, and a rotation direction during the closing operation and a rotation direction during the opening operation are opposite to each other. A worm gear 54 is provided on an output shaft 51a of the motor 51, and the worm gear 54 constitutes a connection portion between the motor 51 and the driving force transmission portion 52.

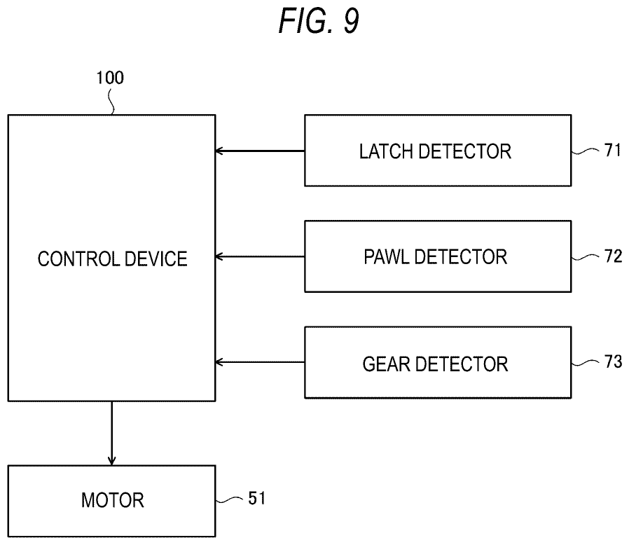

As shown in FIG. 9, the motor 51 is controlled by the control device 100. The control device 100 includes a processor that performs arithmetic processing according to a program, and a memory such as a Read Only Memory (ROM) and a Random Access Memory (RAM). The control device 100 is provided to enable to receive the detection results of the detectors 71, 72, and 73 in a wired or wireless manner, and controls the motor 51 based on these detection results. In addition, for example, the control device 100 is provided to enable to receive a command of an opening operation by a user operating a Frequency Operated Button (FOB) key (not illustrated) or a switch (for example, a physical button, an icon displayed on a touch panel, or the like) provided in a vehicle cabin.

The control device 100 is provided at a position away from the door lock device 10, but may be incorporated in the door lock device 10. In other words, the control device 100 may be accommodated in the cover plate 11 and the housings 23, 53.

Returning to FIGS. 3 to 5, the driving force transmission portion 52 transmits the driving force of the motor 51 to the latch 21 or the pawl 22 of the meshing mechanism 20. The driving force transmission portion 52 also functions as a deceleration mechanism that decelerates the rotation of the motor 51.

Specifically, the driving force transmission portion 52 includes a first gear 55, a second gear 56, a third gear 57, a latch operation portion 58, and a pawl operation portion 59.

The first gear 55, the third gear 57, the latch operation portion 58, and the pawl operation portion 59 rotate about a common first rotation shaft 61 extending in the Z direction, and the second gear 56 rotates about a second rotation shaft 62 extending in the Z direction. The first rotation shaft 61 and the second rotation shaft 62 are supported by the cover plate 11 and the housing 53.

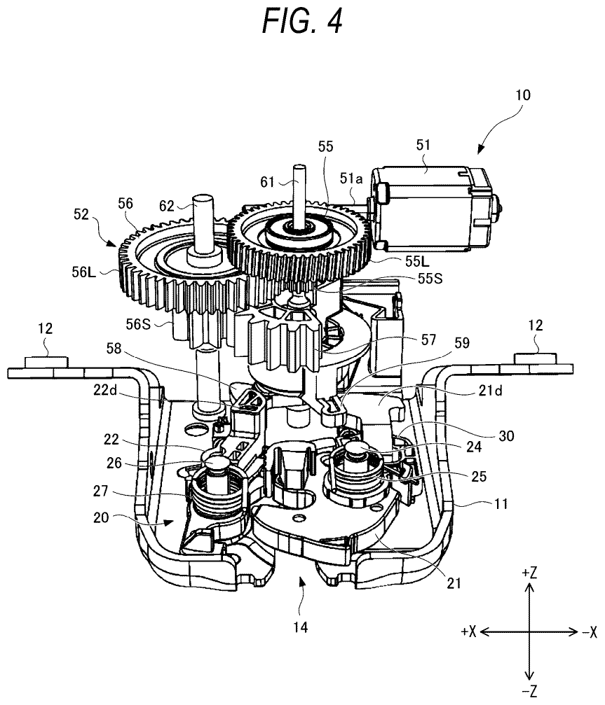

The first rotation shaft 61 is arranged between the latch shaft 24 and the pawl shaft 26 as viewed from the Y direction in which the striker entry groove 14 extends (see FIG. 4). The second rotation shaft 62 is arranged on the +X side of the first rotation shaft 61 as viewed from the Y direction.

The first gear 55 and the second gear 56 mesh with each other, and the second gear 56 and the third gear 57 mesh with each other. More specifically, the first gear 55 includes a large-diameter portion 55L and a small-diameter portion 55S, and similarly, the second gear 56 includes a large-diameter portion 56L and a small-diameter portion 56S. The large-diameter portion 55L of the first gear 55 meshes with the worm gear 54. The small-diameter portion 55S of the first gear 55 meshes with the large-diameter portion 56L of the second gear 56. The small-diameter portion 56S of the second gear 56 meshes with the third gear 57.

As illustrated in FIG. 5, the third gear 57 includes an arc-shaped detected portion 57a that enables to come into contact with the gear detector 73, and a recessed portion 57b that is provided adjacent to the detected portion 57a in the circumferential direction and is recessed inward in the radial direction of the third gear 57. The detected portion 57a and the recessed portion 57b are provided on the −Z side of the tooth portion of the third gear 57. The gear detector 73, the detected portion 57a, and the recessed portion 57b are arranged on the same plane in the Z direction in which the first rotation shaft 61 extends. When the gear detector 73 and the recessed portion 57b face each other, the gear detector 73 is not in contact with the recessed portion 57b and is turned OFF, and when the third gear 57 rotates and the gear detector 73 and the detected portion 57a face each other, the gear detector 73 is in contact with the detected portion 57a and is turned ON.

The latch operation portion 58 is configured as a lever that is spline-coupled to the third gear 57 and rotates integrally with the third gear 57. The latch operation portion 58 extends radially outward from the first rotation shaft 61. When the closing operation is performed on the back door 4 in the half-closed state, the motor 51 is driven in the closing direction. The latch operation portion 58 presses the latch lead-in portion 21d of the latch 21 to rotate the latch 21 against the biasing force of the latch spring 25, and causes the latch 21 to transition from the half latch position to the full latch position. As a result, the striker 3 is drawn into the striker entry groove 14, and the back door 4 is closed.

The pawl operation portion 59 is provided integrally with the third gear 57 and extends radially outward from the first rotation shaft 61. For example, when the opening operation is performed on the back door 4 by operating the FOB key or a switch in the vehicle interior, the motor 51 is driven in the opening direction. The pawl operation portion 59 presses the pressed portion 22d of the pawl 22 to rotate the pawl 22 against the biasing force of the pawl spring 27, thereby releasing the engagement between the latch 21 and the pawl 22. The latch 21 rotates in the open direction by the biasing force of the latch spring 25 and transitions to the unlatched position. As a result, the engagement between the striker 3 and the latch 21 is released, and the back door 4 transitions to the openable state.

In the present embodiment, the latch operation portion 58 is provided separately from the third gear 57, and the pawl operation portion 59 is provided integrally with the third gear 57, but the present invention is not limited thereto. For example, the latch operation portion 58 may be provided integrally with the third gear 57, and the pawl operation portion 59 may be provided separately from the third gear 57.

The latch detector 71 detects the position of the latch 21. The pawl detector 72 detects the position of the pawl 22. The gear detector 73 detects the position of the third gear 57. The latch detector 71, the pawl detector 72, and the gear detector 73 are configured as switches that enable to be switched ON and OFF by coming into contact with the detected portions 30, 22a and 57a, respectively.

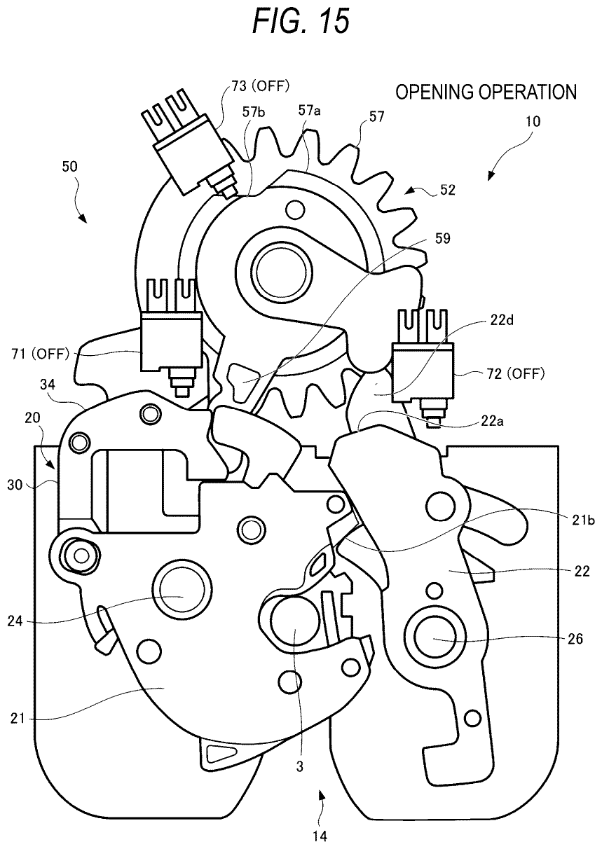

Next, the closing operation and the opening operation by the electric driving mechanism 50 will be described with reference to FIGS. 10 to 14 (closing operation) and FIGS. 15 to 18 (opening operation).

First, the closing operation will be described. When the latch 21 is at the half-latch position, the electric driving mechanism 50 shifts the latch 21 from the half-latch position to the full-latch position by the driving force of the motor 51 based on the detection results of the detectors 71, 72, and 73. As a result, the electric driving mechanism 50 electrically shifts the meshing mechanism 20 to the engaged state in which the meshing mechanism 20 is engaged with the striker 3, and closes the back door 4 in the half closed state to the fully closed position.

As shown in FIG. 10, when the back door 4 is in the openable state, the latch 21 is biased in the opening direction (clockwise direction) by the latch spring 25 to be located at the unlatched position, and is in the disengaged state in which the latch 21 is not engaged with the striker 3. The striker contact portion 21a1 of the latch 21 is positioned so as to cross the striker entering groove 14, and the hook portion 21a2 is positioned so as to be retracted from the striker entering groove 14. The pawl 22 is biased in a direction (counterclockwise direction) in which the pawl 22 enables to mesh with the latch 21 by the pawl spring 27 in a state of being in contact with the pawl contact portion 21e of the latch 21 without meshing with the full-latch meshing portion 21b and the half-latch meshing portion 21c of the latch 21.

When the back door 4 is in the openable state, the latch detector 71 is not in contact with the detected portion 30 attached to the latch 21 and is OFF. The pawl detector 72 is in contact with the detected portion 22a of the pawl 22 and is ON. The gear detector 73 is not in contact with the detected portion 57a of the third gear 57 and is OFF.

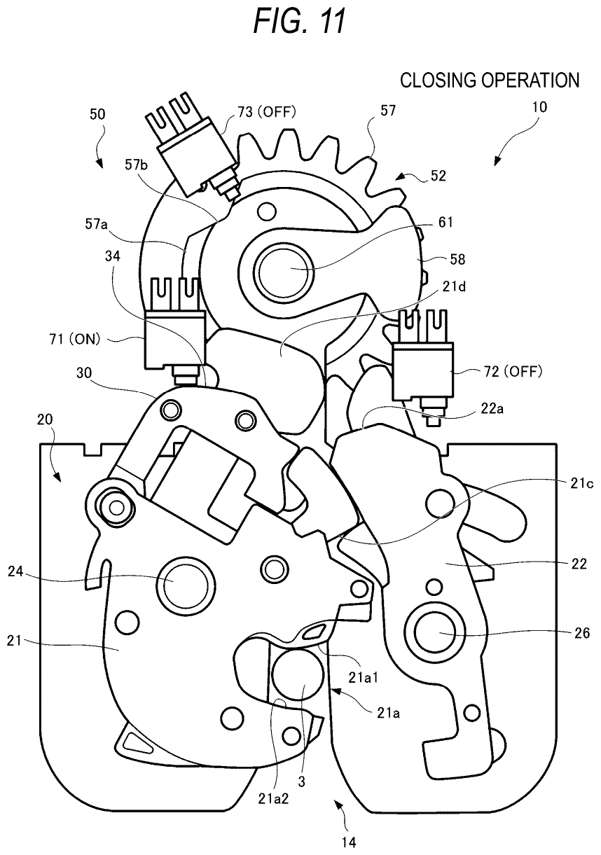

As shown in FIG. 11, when the operation for closing the back door 4 is performed and the striker 3 enters the striker entry groove 14, the back door 4 is in the half door state. Specifically, the striker 3 that has entered the striker entry groove 14 comes into contact with the striker contact portion 21a1 of the latch 21 and presses the striker contact portion 21a1. Then, the striker 3 rotates the latch 21 in the closing direction against the biasing force of the latch spring 25, and the pawl 22 slides on the pawl contact portion 21e and meshes with the half latch meshing portion 21c of the latch 21. Accordingly, the latch 21 transitions from the unlatch position to the half-latch position. At this time, the striker 3 is accommodated in the accommodation groove 21a formed between the striker contact portion 21a1 and the hook portion 21a2.

When the back door 4 is in the half closed state, the latch detector 71 is in contact with the detected portion 30 attached to the latch 21 and is ON. The pawl detector 72 is not in contact with the detected portion 22a of the pawl 22 and is OFF. In the present embodiment, in the process in which the back door 4 transitions from the openable state to the half closed state, the latch detector 71 first switches from OFF to ON, and then the pawl detector 72 switches from ON to OFF.

When detecting that the latch detector 71 is switched to ON and the pawl detector 72 is switched to OFF, the control device 100 determines that the latch 21 has transitioned from the unlatch position to the half latch position. Then, the controller 100 drives the motor 51 in the closing direction to rotate the latch operation portion 58 located at the predetermined neutral position.

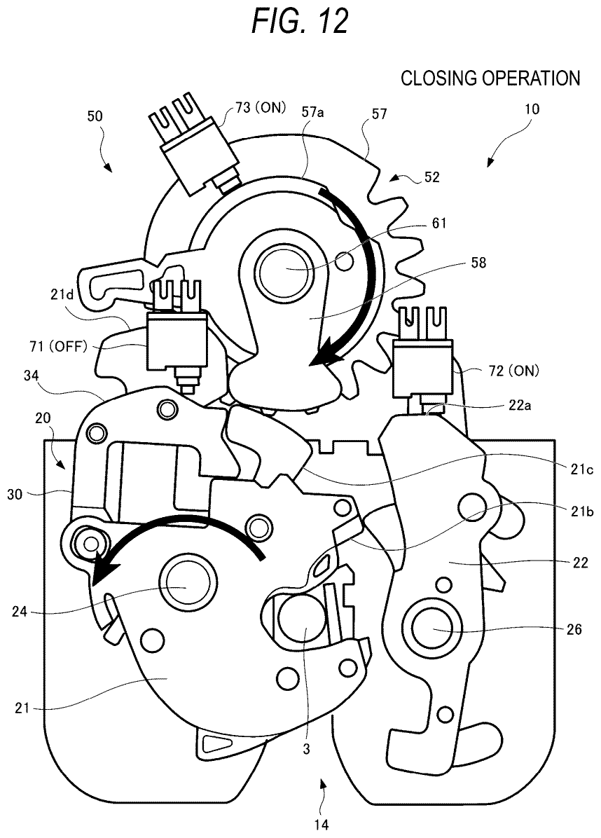

As shown in FIG. 12, when the motor 51 is driven in the closing direction, the latch 21 rotates from the half latch position toward the full latch position. Specifically, the latch operation portion 58 rotates toward the latch lead-in portion 21d and presses the latch lead-in portion 21d. Accordingly, the latch 21 rotates in the closing direction against the biasing force of the latch spring 25, and the striker 3 is drawn by the latch 21 and further enters the striker entry groove 14. The engagement between the pawl 22 and the half-latch meshing portion 21c of the latch 21 is released.

When the motor 51 is driven in the closing direction, the gear detector 73 comes into contact with the detected portion 57a of the third gear 57 by the rotation of the third gear 57, and is switched from OFF to ON. The pawl detector 72 is temporarily turned ON after the pawl 22 is disengaged from the half-latch meshing portion 21c until the pawl 22 is meshed with the full-latch meshing portion 21b. When the rotation of the latch 21 progresses, the latch detector 71 does not come into contact with the detected portion 30 and switches from ON to OFF.

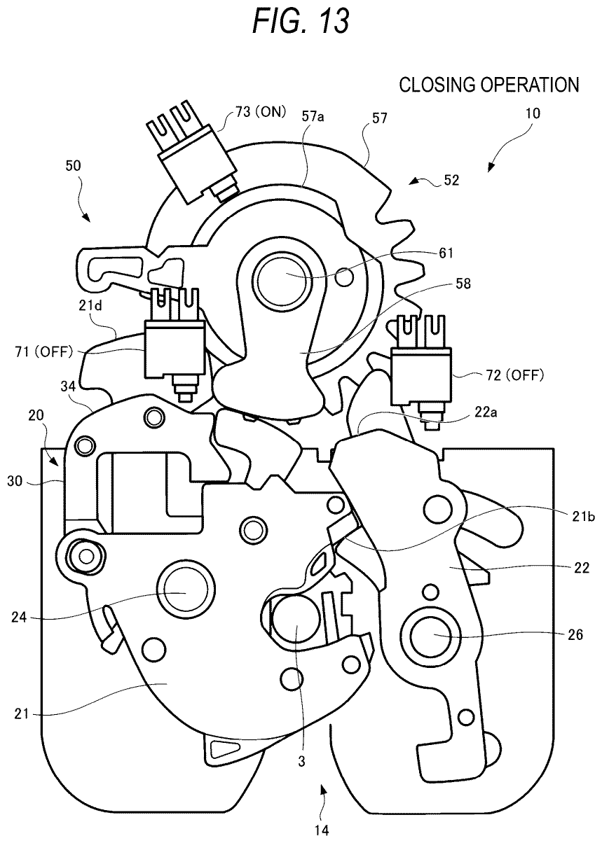

As shown in FIG. 13, when the rotation of the latch 21 progresses, the pawl 22 meshes with the full-latch meshing portion 21b. This state corresponds to a fully closed state in which the back door 4 is completely engaged with the striker 3. When the pawl 22 meshes with the full-latch meshing portion 21b, the pawl detector 72 does not come into contact with the detected portion 22a, and is switched from ON to OFF. At this time, the latch detector 71 is OFF and the gear detector 73 is ON,

When the control device 100 detects that the pawl detector 72 is switched from ON to OFF in a state where the latch detector 71 is OFF and the gear detector 73 is ON, the control device 100 determines that the latch 21 has transitioned from the half latch position to the full latch position. Then, the control device 100 stops driving the motor 51.

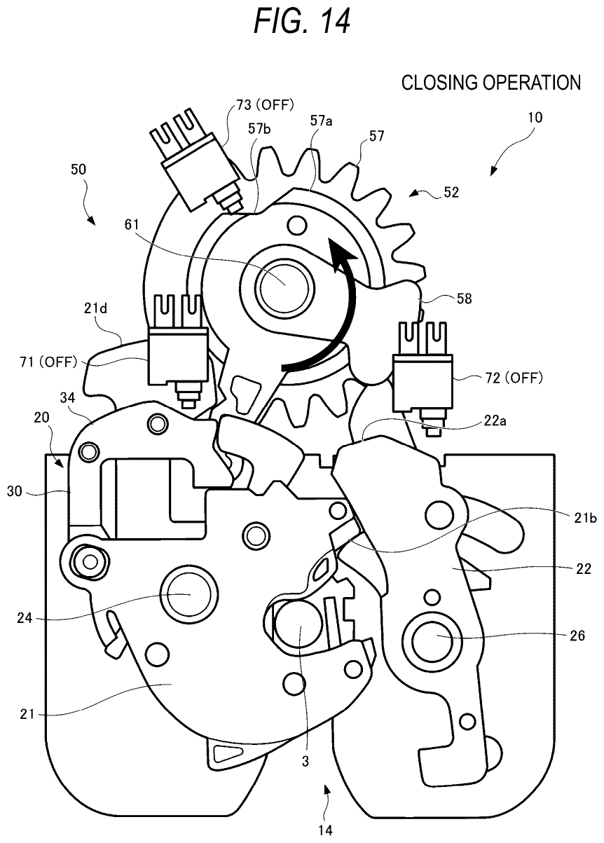

As illustrated in FIG. 14, after the latch 21 transitions to the full-latch position, the control device 100 drives the motor 51 in the direction opposite to the closing direction to return the latch operation portion 58 to the neutral position. When detecting that the gear detector 73 has been switched from ON to OFF, the control device 100 determines that the latch operation portion 58 has returned to the neutral position, and stops driving the motor 51. As described above, when the back door 4 is in the fully closed state, the detectors 71, 72, and 73 are all OFF.

Next, the opening operation will be described. When the meshing mechanism 20 is in the engaged state in which the meshing mechanism 20 is engaged with the striker 3, the electric driving mechanism 50 releases the meshing between the latch 21 and the pawl 22 by rotating the motor 51 in the opening direction opposite to the closing direction based on the detection results of the detectors 71, 72, and 73. As a result, the electric driving mechanism 50 releases the engagement state of the meshing mechanism 20 and brings the back door 4 into the openable state.

As illustrated in FIG. 15, when the back door 4 is in the fully closed state, the pawl 22 meshes with the full-latch meshing portion 21b of the latch 21, and the latch 21 is located at the full-latch position. At this time, the detectors 71, 72, and 73 are all OFF.

When the control device 100 receives the command to perform the opening operation, the control device 100 drives the motor 51 in the open direction to rotate the pawl operation portion 59 at the neutral position.

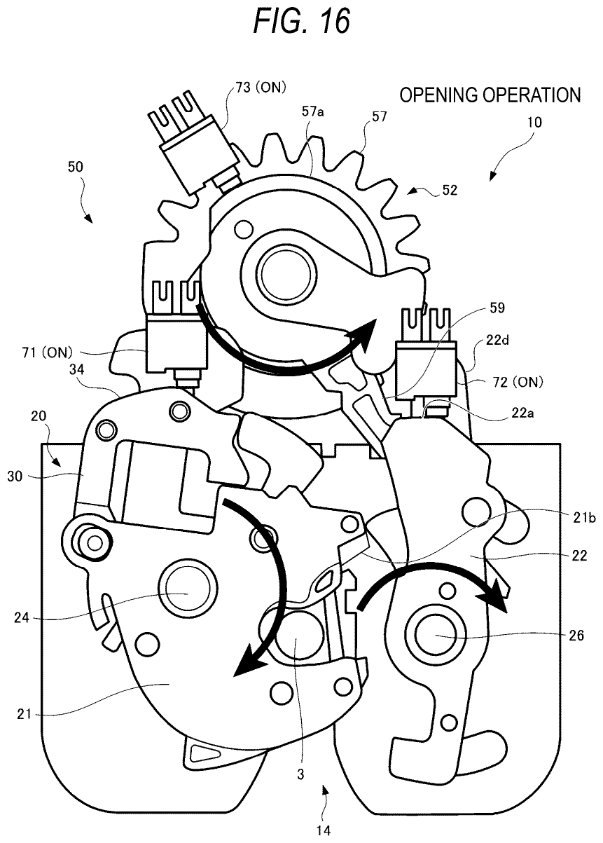

As shown in FIG. 16, when the motor 51 is driven in the opening direction, the pawl operation portion 59 rotates toward the pressed portion 22d of the pawl 22 and presses the pressed portion 22d. By the pressing by the pawl operation portion 59, the pawl 22 rotates against the biasing force of the pawl spring 27, and the engagement between the pawl 22 and the full-latch meshing portion 21b of the latch 21 is released. The latch 21 rotates in the opening direction by the biasing force of the latch spring 25.

When the motor 51 is driven in the opening direction, the gear detector 73 comes into contact with the detected portion 57a of the third gear 57 by the rotation of the third gear 57 and switches from OFF to ON. When the engagement between the pawl 22 and the full-latch meshing portion 21b of the latch 21 is released, the pawl detector 72 comes into contact with the detected portion 22a of the pawl 22 and switches from OFF to ON. The pawl detector 72 is kept ON while the detected portion 22a of the pawl 22 is pressed by the pawl operation portion 59. When the pawl detector 72 is switched from OFF to ON in a state where the gear detector 73 is ON, the control device 100 determines that the pawl 22 has transitioned to a position where the pawl 22 is disengaged from the latch 21, and stops driving the motor 51. Immediately after the engagement between the latch 21 and the pawl 22 is released, the latch detector 71 temporarily comes into contact with the detected portion 30 and switches from OFF to ON.

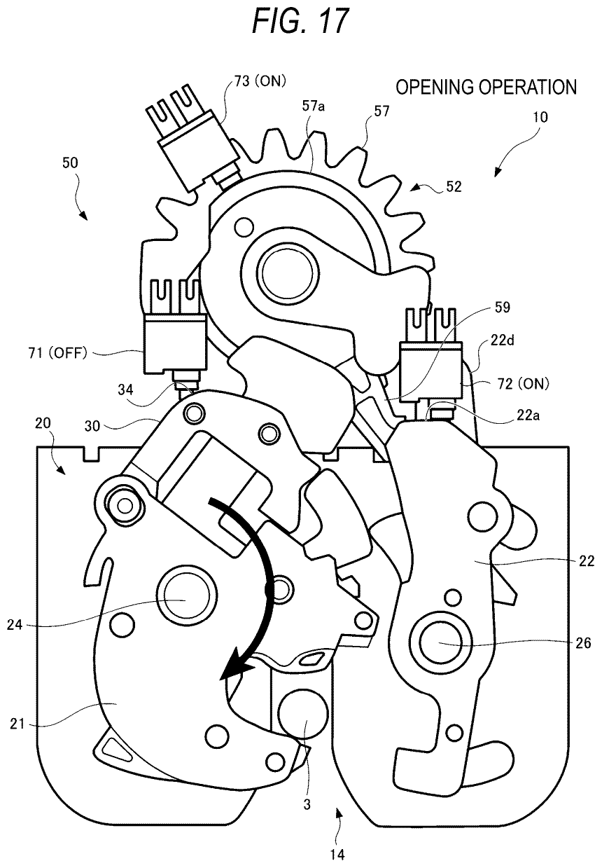

As shown in FIG. 17, when the rotation of the latch 21 in the opening direction progresses, the engagement between the latch 21 and the striker 3 is released. The latch detector 71 does not come into contact with the detected portion 30 and switches from ON to OFF. Accordingly, the control device 100 determines that the latch 21 has transitioned from the full-latch position to the unlatch position.

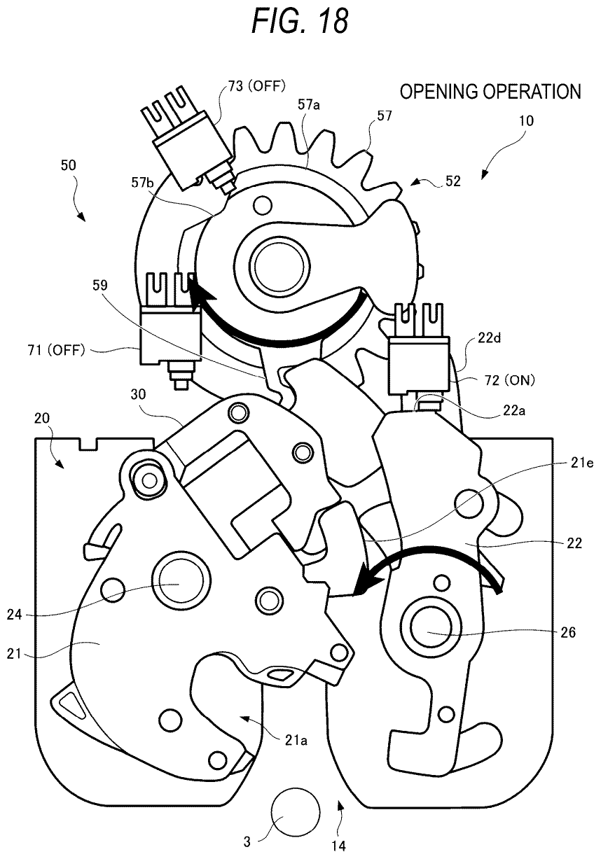

As illustrated in FIG. 18, after the latch 21 transitions to the unlatch position, the control device 100 drives the motor 51 in the direction opposite to the opening direction to return the pawl operation portion 59 to the neutral position. The pawl 22 comes into contact with the pawl contact portion 21e of the latch 21 by the biasing force of the pawl spring 27. When the control device 100 detects that the gear detector 73 has been switched from ON to OFF, the control device 100 determines that the pawl operation portion 59 has returned to the neutral position and stops driving the motor 51. Thus, when the back door 4 is in the openable state, the latch detector 71 and the gear detector 73 are OFF, and the pawl detector 72 is ON. 69 Effects of the door lock device 10 of the present embodiment described above will be described.

The latch detector 71 comes into contact with the detected portion 30 rotating integrally with the latch 21 to detect the position of the latch 21. If the detected portion 30 is configured as a lever that does not rotate integrally with the latch 21 and moves in conjunction with the latch 21 with one end in contact with the latch 21, the movement of the detected portion 30 and the movement of the latch 21 may deviate due to variations in the dimensions of the detected portion 30 or variations in the attachment to the latch 21. In the present embodiment, since the detected portion 30 rotates integrally with the latch 21, the movement of the detected portion 30 is equal to the movement of the latch 21, and the latch detector 71 can accurately detect the position of the latch 21.

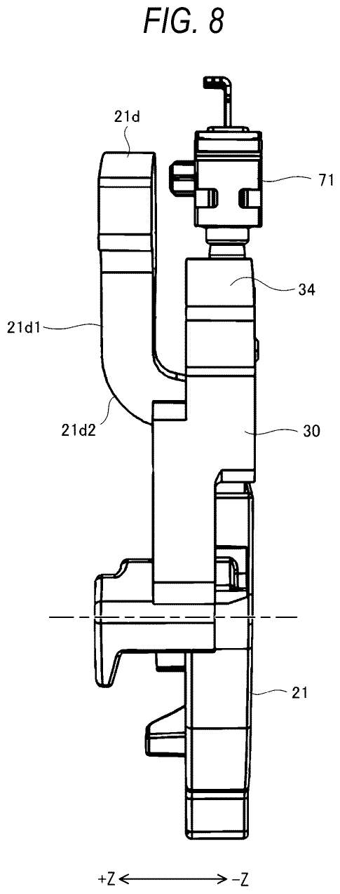

As illustrated in FIGS. 5 and 8, the latch lead-in portion 21d and the latch detector 71 are arranged at positions different from each other in the axial direction (Z direction) of the latch 21, and where at least parts the latch lead-in portion 21d and the latch detector 71 overlap each other as viewed from the axial direction. According to this configuration, the space in the Z direction in the door lock device 10 can be efficiently utilized. Therefore, the size of the door lock device 10 can be reduced.

As illustrated in FIGS. 6 to 8, the latch lead-in portion 21d is formed by bending the extension portion 21d1 of the metal portion 21A of the latch 21. That is, in the present embodiment, the configuration in which the latch 21 and the latch lead-in portion 21d are arranged at different positions in the Z direction is realized by the bending process.

Since the latch lead-in portion 21d is formed by bending the metal portion 21A of the latch 21, the latch lead-in portion 21d is formed integrally with the metal portion 21A of the latch 21. If the latch lead-in portion 21d is provided separately from the latch 21, the movement of the latch lead-in portion 21d and the latch 21 may be deviated due to a variation in the dimension of the latch lead-in portion 21d or a variation in the attachment to the latch 21. In this embodiment, since the latch 21 and the latch lead-in portion 21d are integrally formed, the movement of the latch lead-in portion 21d is equal to the movement of the latch 21, and the stable closing operation is possible.

In addition, since the latch lead-in portion 21d is formed by the metal portion 21A of the latch 21, the latch lead-in portion 21d has the same strength as the metal portion 21A of the latch 21, and the strength of the latch lead-in portion 21d can be secured. Furthermore, since the latch lead-in portion 21d is formed integrally with the latch 21, the number of components can be reduced.

As illustrated in FIGS. 14 and 15, when the latch 21 is in the engaged state in which the latch 21 is engaged with the striker 3, the extending direction of the latch lead-in portion 21d is substantially parallel to the extending direction of the striker entry groove 14. According to this configuration, the rotation locus of the latch lead-in portion 21d when the back door 4 transitions between the openable state and the fully closed state falls within the operation region A1 (see FIG. 5) of the latch 21 and the pawl 22 in the X direction. Therefore, since the latch lead-in portion 21d does not protrude from the operation region A1 in the X direction, the dimension of the door lock device 10 in the X direction is reduced, and the door lock device 10 can be miniaturized.

As shown in FIG. 7, the detected portion 30 is provided as a separate component from the latch 21, and is attached to rotate integrally with the latch 21. According to this configuration, the degree of freedom in designing the material, shape, arrangement, and the like of the detected portion 30 can be increased. For example, when the detected portion 30 is formed of a material different from that of the resin portion 21B of the latch 21 or when the arrangement of the latch detector 71 is changed, the arrangement change of the latch detector 71 can be handled by changing the shape of the detected portion 30.

Since the first attachment portion 31 of the detected portion 30 is formed from the through hole through which the latch shaft 24 is inserted, the detected portion 30 can be prevented from falling off. Further, since the detected portion 30 is positioned with respect to the latch 21 by inserting the latch shaft 24 into the first attachment part 31 and the through hole 21s of the latch 21, the variation when attaching the detected portion 30 to the latch 21 affects only the second attachment part 32. That is, it is possible to reduce variation factors at the time of attachment of the detected portion 30.

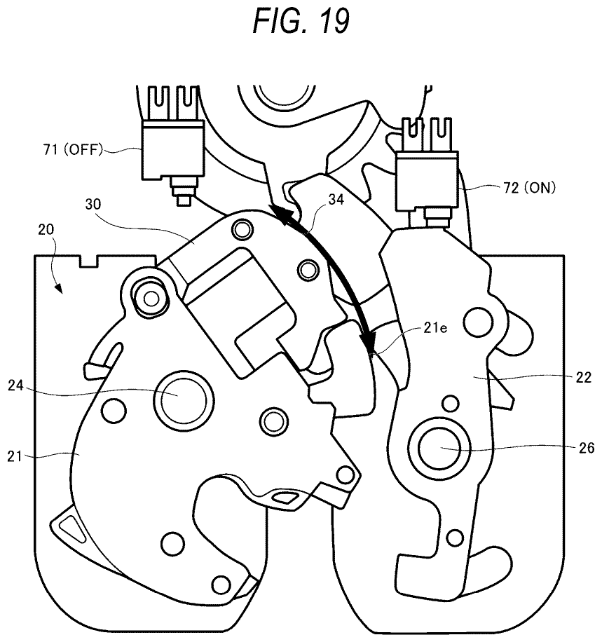

As illustrated in FIG. 19, the contact surface 34 of the detected portion 30 with the latch detector 71 is arranged on the rotation locus (thick arrow in FIG. 19) of the pawl contact portion 21e, which is adjacent to the detected portion 30, on the outer peripheral surface of the latch 21. According to this configuration, since the detected portion 30 does not protrude

radially outward with respect to the latch 21, the door lock device 10 can be miniaturized. The contact surface 34 may be arranged radially inward of the rotation locus of the pawl contact portion 21e.

As described above, the electric driving mechanism 50 includes the motor 51 capable of forward and reverse rotation, and is configured to be capable of performing the closing operation for electrically closing the back door 4 by rotating the motor 51 in one direction, and the opening operation for electrically releasing the engagement between the striker 3 and the latch 21 by rotating the motor 51 in the other direction. As described above, since the opening operation and the closing operation can be performed by the single motor 51, it is not necessary to provide two motors for the opening operation and the closing operation, and the manufacturing cost of the door lock device 10 can be reduced.

As shown in FIGS. 4 and 5, the first rotation shaft 61 and the second rotation shaft 62 of the electric driving mechanism 50 extend in the same Z direction as the direction in which the latch shaft 24 and the pawl shaft 26 of the meshing mechanism 20 extend. Since the extending directions of the respective shafts are the same, the respective components of the meshing mechanism 20 and the electric driving mechanism 50 are assembled so as to be stacked from the same direction (one direction), and thus it is possible to easily assemble the respective components of the meshing mechanism 20 and the electric driving mechanism 50. As a result, the size of the door lock device 10 can be reduced.

The first rotation shaft 61 is arranged between the latch shaft 24 and the pawl shaft 26 as viewed from the Y direction in which the striker entry groove 14 extends. According to this configuration, the latch operation portion 58 and the pawl operation portion 59 rotating around the first rotation shaft 61 are within n the operation region A1 of the latch 21 and the pawl 22 in the X direction. Therefore, since the latch operation portion 58 and the pawl operation portion 59 do not protrude from the operation region A1 in the X direction, the dimension of the door lock device 10 in the X direction is reduced, and the door lock device 10 can be miniaturized.

Further, the latch operation portion 58 and the pawl operation portion 59 are arranged between the latch shaft 24 and the pawl shaft 26, that is, the latch operation portion 58 and the pawl operation portion 59 are arranged at positions where the latch operation portion 58 and the pawl operation portion 59 easily come into contact with the latch lead-in portion 21d and the pressed portion 22d of the pawl 22, respectively, when the motor 51 is rotated in forward and reverse. Therefore, the closing operation and the opening operation can be efficiently performed by forward and reverse rotation of the motor 51.

Although an embodiment of the present disclosure has been described above with reference to the accompanying drawings, it goes without saying that the present invention is not limited to the embodiment. It should be understood by those skilled in the art that various modifications, combinations, sub-combinations and alterations may occur depending on design requirements and other factors insofar as they are within the scope of the appended claims or the equivalents thereof. In addition, the components in the above-described embodiments may be arbitrarily combined without departing from the gist of the invention.

For example, in the above-described embodiment, the detected portion 30 is provided as the separate component from the latch 21, but the detected portion 30 may be formed integrally with the latch 21.

Further, in the above-described embodiment, the latch lead-in portion 21d is formed integrally with the latch 21, but the latch lead-in portion 21d may be provided as a separate component from the latch 21. Further, in the above-described embodiment, the latch operation portion 58 and the pawl operation portion 59 rotate about the common first rotation shaft 61, but the latch operation portion 58 and the pawl operation portion 59 may be configured to rotate about rotation shafts being different from each other.

Further, the lock device of the present disclosure is not limited to being applied to the back door as in the above-described embodiment, and can be applied to an opening and closing body of a vehicle other than the back door. Specifically, the lock device of the present disclosure is also applicable to a side door of a vehicle, an engine hood of a vehicle, and the like (both are examples of the opening and closing body).

At least the following matters are described in the present specification. The corresponding components and the like in the above-described embodiment are shown in parentheses as an example, but the present invention is not limited thereto.
(1) A lock device (door lock device 10) configured to be engaged with a striker (striker 3) provided in a vehicle (vehicle 1) to hold an opening and closing body (back door 4) of the vehicle in a closed state, the lock device including:
   a meshing mechanism (meshing mechanism 20) including a latch (latch 21) configured to be engaged with the striker, and a pawl (pawl 22) configured to maintain an engaged state in which the striker and the latch are engaged with each other;
   a latch detector (latch detector 71) configured to detect a position of the latch by coming into contact with a detected portion (detected portion 30) that rotates integrally with the latch;
   an electric driving mechanism (electric driving mechanism 50) including a motor (motor 51) and a driving force transmission portion (driving force transmission portion 52) configured to transmit a driving force of the motor, the electric driving mechanism being configured to perform a closing operation for electrically shifting the electric driving mechanism to the engaged state based on a detection result of the latch detector, in which
   the meshing mechanism is provided with a latch lead-in portion (latch lead-in portion 21d) provided in conjunction with the latch and configured to receive a driving force of the motor transmitted from the driving force transmission portion in a case where the electric driving mechanism performs the closing operation, and
   the latch lead-in portion and the latch detector are arranged at positions different from each other in an axial direction of the latch, and where at least parts of the latch lead-in portion and the latch detector overlap each other as viewed from the axial direction.

According to (1), the movement of the detected portion is equal to the movement of the latch, and the latch detector can accurately detect the position of the latch. In addition, since the latch lead-in portion and the latch detector are arranged at positions different from each other in the axial direction of the latch, and where at least parts thereof overlap each other as viewed from the axial direction, the space in the axial direction can be efficiently utilized, and the size of the lock device can be reduced.
(2) In the lock device according to (1), in a case where the meshing mechanism is in the engaged state, the electric driving mechanism is configured to perform an opening operation for releasing the engaged state of the meshing mechanism by rotating the motor in a direction opposite to the closing operation.

According to (2), it is possible to perform the opening operation and the closing operation with the single motor. Therefore, it is not necessary to provide two motors for the opening operation and the closing operation, and the manufacturing cost of the lock device can be reduced.
(3) In the lock device according to (1) or (2), the latch lead-in portion is formed by bending a part of a metal portion (metal portion 21A) of the latch.

If the latch lead-in portion is provided separately from the latch, the movement of the latch lead-in portion and the latch may be deviated due to a variation in the dimension of the latch lead-in portion or a variation in the attachment to the latch. According to (3), since the latch lead-in portion is formed integrally with the metal portion of the latch by the bending process, the latch lead-in portion rotates integrally with the latch, and a stable closing operation is possible. In addition, since the latch lead-in portion is formed integrally with the metal portion of the latch, the strength of the latch lead-in portion is the same as that of the metal portion of the latch, and the strength of the latch lead-in portion can be secured. Furthermore, the number of components can be reduced.
(4) In the lock device according to any one of (1) to (3), the latch and the pawl are arranged to sandwich a striker entry groove (striker entry groove 14) into which the striker enables to enter,
   the latch lead-in portion is provided to extend to an outer peripheral side of the latch, and
   an extension direction of the latch lead-in portion is substantially parallel to an extension direction of the striker entry groove in a case where the meshing mechanism is in the engaged state.

According to (4), since the latch lead-in portion and the entering direction of the striker are substantially parallel to each other in the case where the meshing mechanism is in the engaged state, the rotation locus of the latch lead-in portion is within the operation region of the latch and the pawl in the direction orthogonal to the extending direction of the striker entering groove. Therefore, the lock device can be downsized.
(5) In the lock device according to any one of (1) to (3), the latch and the pawl are arranged to sandwich a striker entry groove (striker entry groove 14) into which the striker enables to enter,
   the latch lead-in portion is provided to extend to an outer peripheral side of the latch, and
   a rotation locus of the latch lead-in portion is within an operation region (operation region A1) of the latch and the pawl in a direction orthogonal to the striker entry groove.

According to (5), the rotation locus of the latch lead-in portion is within the operation region of the latch and the pawl in the direction orthogonal to the direction in which the striker entry groove extends. Therefore, the lock device can be downsized.
(6) In the lock device according to any one of (1) to (5), the detected portion is provided as a separate component from the latch.

According to (6), since the detected portion is provided separately from the latch, it is possible to increase the degree of freedom in designing the material, shape, arrangement, and the like of the detected portion.
(7) In the lock device according to (6), the detected portion includes at least two attachment portions (first attachment portion 31 and second attachment portion 32) that are attachment parts where the latch is attached, and
one of the attachment portions (first attachment portion 31) is formed from a through hole through which a latch shaft (latch shaft 24) serving as a rotation axis of the latch is inserted.

According to (7), since the detected portion is inserted through the latch shaft and attached to the latch, the detected portion provided separately from the latch can be prevented from falling off. In addition, since the detected portion is positioned with respect to the latch by the latch shaft, it is possible to reduce variation factors when the detected portion is attached.
(8) In the lock device according to (6) or (7), a contact surface (contact surface 34) of the detected portion with the latch detector is arranged on a rotation locus of a portion (pawl contact portion 21e) adjacent to the detected portion on an outer peripheral surface of the latch, or is arranged radially inward of the rotation locus.

According to (8), since the detected portion does not protrude radially outward with respect to the latch, the lock device can be miniaturized.
(9) In the lock device according to (2), the latch and the pawl are arranged to sandwich a striker entry groove (striker entry groove 14) into which the striker enables to enter,
   the driving force transmission portion includes:
      a latch operation portion (latch operation portion 58) configured to press the latch lead-in portion when the closing operation is performed; and
      a pawl operation portion (pawl operation portion 59) configured to press the pawl when the opening operation is performed, and
a rotation shaft (first rotation shaft 61) of the latch operation portion and the pawl operation portion extends in a direction identical to rotation axes (latch shaft 24 and pawl shaft 26) the latch and the pawl, and is arranged between the rotation axis of the latch and the rotation axis of the pawl as viewed from an extending direction of the striker entry groove.

According to (9), since the rotation shaft of the latch operation portion and the pawl operation portion extends in the same direction as the rotation axes of the latch and the pawl, it is possible to easily assemble each component of the electric driving mechanism to the meshing mechanism, and as a result, it is possible to reduce the size of the lock device. In addition, since the rotation shaft of the latch operation portion and the pawl operation portion is arranged between the rotation axis of the latch and the rotation axis of the pawl as viewed from the extending direction of the striker entry groove, the latch operation portion and the pawl operation portion do not protrude from the operation regions of the latch and the pawl, and the lock device can be miniaturized. Further, the latch operation portion and the pawl operation portion are arranged at positions where the latch operation portion and the pawl operation portion easily come into contact with the latch lead-in portion and a pressed portion of the pawl, respectively, when the motor is rotated in forward and reverse. Therefore, the closing operation and the opening operation can be efficiently performed by forward and reverse rotation of the motor.

What is claimed is:

1. A lock device configured to be engaged with a striker provided in a vehicle to hold an opening and closing body of the vehicle in a closed state, the lock device comprising:
a meshing mechanism including a latch configured to be engaged with the striker, and a pawl configured to maintain an engaged state in which the striker and the latch are engaged with each other;
a latch detector configured to detect a position of the latch by coming into contact with a detected portion that rotates integrally with the latch; and
an electric driving mechanism including a motor and a driving force transmission portion configured to transmit a driving force of the motor, the electric driving mechanism being configured to perform a closing operation for electrically shifting the meshing mechanism to the engaged state based on a detection result of the latch detector, wherein
the meshing mechanism is provided with a latch lead-in portion provided in conjunction with the latch and configured to receive a driving force of the motor transmitted from the driving force transmission portion in a case where the electric driving mechanism performs the closing operation, and
the latch lead-in portion and the latch detector are arranged at positions different from each other in an axial direction of the latch, and where at least parts of the latch lead-in portion and the latch detector overlap each other as viewed from the axial direction.

2. The lock device according to claim 1, wherein
in a case where the meshing mechanism is in the engaged state, the electric driving mechanism is configured to perform an opening operation for releasing the engaged state of the meshing mechanism by rotating the motor in a direction opposite to the closing operation.

3. The lock device according to claim 1, wherein
the latch lead-in portion is formed by bending a part of a metal portion of the latch.

4. The lock device according to claim 1, wherein
the latch and the pawl are arranged to sandwich a striker entry groove into which the striker enables to enter,
the latch lead-in portion is provided to extend to an outer peripheral side of the latch, and
an extending direction of the latch lead-in portion is substantially parallel to an extending direction of the striker entry groove in a case where the meshing mechanism is in the engaged state.

5. The lock device according to claim 1, wherein
the latch and the pawl are arranged to sandwich a striker entry groove into which the striker enables to enter,
the latch lead-in portion is provided to extend to an outer peripheral side of the latch, and
a rotation locus of the latch lead-in portion is within an operation region of the latch and the pawl in a direction orthogonal to the striker entry groove.

6. The lock device according to claim 1, wherein
the detected portion is provided as a separate component from the latch.

7. The lock device according to claim 6, wherein
the detected portion includes at least two attachment portions that are attachment parts where the latch is attached, and
one of the attachment portions is formed from a through hole through which a latch shaft serving as a rotation axis of the latch is inserted.

8. The lock device according to claim 6, wherein
a contact surface of the detected portion with the latch detector is arranged on a rotation locus of a portion adjacent to the detected portion on an outer peripheral surface of the latch, or is arranged radially inward of the rotation locus.

9. The lock device according to claim 2, wherein
the latch and the pawl are arranged to sandwich a striker entry groove into which the striker enables to enter,
the driving force transmission portion includes:
a latch operation portion configured to press the latch lead-in portion when the closing operation is performed; and
a pawl operation portion configured to press the pawl when the opening operation is performed, and
a rotation shaft of the latch operation portion and the pawl operation portion extends in a direction identical to rotation axes of the latch and the pawl, and is arranged between the rotation axis of the latch and the rotation axis of the pawl as viewed from an extending direction of the striker entry groove.
